(19) United States
(12) Patent Application Publication
(10) Pub. No.: US 2024/0378664 A1
(43) Pub. Date: Nov. 14, 2024

(54) TRANSACTION SUPPORT APPARATUS, TRANSACTION SUPPORT METHOD, AND COMPUTER READABLE MEDIUM

(71) Applicant: MITSUBISHI ELECTRIC CORPORATION, Tokyo (JP)

(72) Inventor: Kenichi KOIZUMI, Tokyo (JP)

(73) Assignee: MITSUBISHI ELECTRIC CORPORATION, Tokyo (JP)

(21) Appl. No.: 18/781,045

(22) Filed: Jul. 23, 2024

Related U.S. Application Data
(63) Continuation of application No. PCT/JP2022/012336, filed on Mar. 17, 2022.

(51) Int. Cl. G06Q 30/08; G06Q 10/083; G06Q 30/0283

(52) U.S. Cl. CPC G06Q 30/08; G06Q 10/083; G06Q 30/0283

(57) ABSTRACT

When a listing item that requires transportation has been listed by a seller, a transportation disclosing processing unit (121) discloses transportation condition information indicating a condition of the transportation of the listing item, using a communication network. A transportation bid processing unit (122) receives from a transportation service provider, transportation bid price information indicating a transportation bid price which is a bid price for a transportation cost of the listing item, using the communication network. A bid notification processing unit (114) transmits to the seller, bid notification information that notifies of the transportation bid price, using the communication network.

### CROSS REFERENCE TO RELATED APPLICATIONS

This application is a Continuation of PCT International Application No. PCT/JP2022/012336, filed on Mar. 17, 2022, all of which is hereby expressly incorporated by reference into the present application.

### TECHNICAL FIELD

The present disclosure relates to a technique to support a transaction of an item.

### BACKGROUND ART

As the technique to support the transaction of the item, there is, for example, a technique described in Patent Literature 1.

Patent Literature 1 discloses a transaction system that smoothly progresses a transaction between a seller and a successful bidder.

### CITATION LIST

### Patent Literature

Patent Literature 1: JP 6241037 B2

### SUMMARY OF INVENTION

### Technical Problem

When a location of the seller is far from a location of the successful bidder, the seller needs to arrange a transportation service provider, and to cause the transportation service provider to transport the item.

Generally, a transportation cost varies depending on transportation service providers. Therefore, when the seller pays a part or all of the transportation cost, it is preferable to disclose a condition of transportation of a listing item, and solicit a bid for the transportation cost from the transportation service provider.

By doing so, the seller can make the most profitable transaction in total including the transportation cost.

However, the technique of Patent Literature 1 cannot solicit the bid for the transportation cost. Therefore, the technique of Patent Literature 1 has a problem in that the seller cannot make the most profitable transaction in total including the transportation cost.

One of main purposes of the present disclosure is to solve such a problem. Specifically, the present disclosure mainly aims to enable the seller to make the most profitable transaction in total including the transportation cost.

### Solution to Problem

A transaction support apparatus according to the present disclosure includes:
an information disclosing unit, when a listing item that requires transportation has been listed by a seller, to disclose transportation condition information indicating a condition of the transportation of the listing item, using a communication network;
a transportation bid price information reception unit to receive from a transportation service provider, transportation bid price information indicating a transportation bid price which is a bid price for a transportation cost of the listing item, using the communication network; and
a bid notification information transmission unit to transmit to the seller, bid notification information that notifies of the transportation bid price, using the communication network.

### Advantageous Effects of Invention

According to the present disclosure, a seller can make the most profitable transaction in total including a transportation cost.

### BRIEF DESCRIPTION OF DRAWINGS

FIG. 1 is a diagram illustrating a configuration diagram of a transaction support system according to Embodiment 1.

FIG. 2 is a diagram illustrating an overview of operation of the transaction support system according to Embodiment 1.

FIG. 3 is a diagram illustrating a functional configuration example of a transaction support apparatus according to Embodiment 1.

FIG. 4 is a flowchart illustrating an operation example of the transaction support apparatus according to Embodiment 1.

FIG. 5 is a flowchart illustrating a listing request acceptance process according to Embodiment 1.

FIG. 6 is a flowchart illustrating a listing disclosing process according to Embodiment 1.

FIG. 7 is a flowchart illustrating a purchase bid acceptance process according to Embodiment 1.

FIG. 8 is a flowchart illustrating a transportation disclosing process according to Embodiment 1.

FIG. 9 is a flowchart illustrating a transportation bid acceptance process according to Embodiment 1.

FIG. 10 is a flowchart illustrating a bid notification process according to Embodiment 1.

FIG. 11 is a diagram illustrating an example of listing candidate data according to Embodiment 1.

FIG. 12 is a diagram illustrating an example of a listing candidate list according to Embodiment 1.

FIG. 13 is a diagram illustrating an example of facility data according to Embodiment 1.

FIG. 14 is a diagram illustrating an example of monitoring data according to Embodiment 1.

FIG. 15 is a diagram illustrating an example of purchase reference price calculation data according to Embodiment 1.

FIG. 16 is a diagram illustrating an example of listing item introduction information according to Embodiment 1.

FIG. 17 is a diagram illustrating an example of a purchase bid message according to Embodiment 1.

FIG. 18 is a diagram illustrating an example of the purchase bid message according to Embodiment 1.

FIG. 19 is a diagram illustrating an example of transportation reference price calculation data according to Embodiment 1.

FIG. 20 is a diagram illustrating an example of transportation condition information according to Embodiment 1.

FIG. 21 is a diagram illustrating an example of a transportation bid message according to Embodiment 1.

FIG. 22 is a diagram illustrating an example of bid notification information according to Embodiment 1.

FIG. 23 is a diagram illustrating an example of service provider data according to Embodiment 1.

FIG. 24 is a diagram illustrating a selection example of a bid price by a seller according to Embodiment 1.

FIG. 25 is a diagram illustrating an example of the listing item introduction information according to Embodiment 2.

FIG. 26 is a diagram illustrating an example of the purchase bid message according to Embodiment 2.

FIG. 27 is a diagram illustrating an example of the purchase bid message according to Embodiment 2.

FIG. 28 is a diagram illustrating an example of the bid notification information according to Embodiment 2.

FIG. 29 is a hardware configuration example of the transaction support apparatus according to Embodiment 1.

### DESCRIPTION OF EMBODIMENTS

Embodiments will be described hereinafter with reference to the drawings. In the following description of the embodiments and the drawings, portions denoted by the same reference signs indicate the same or corresponding portions.

### Embodiment 1

### Description of Configuration

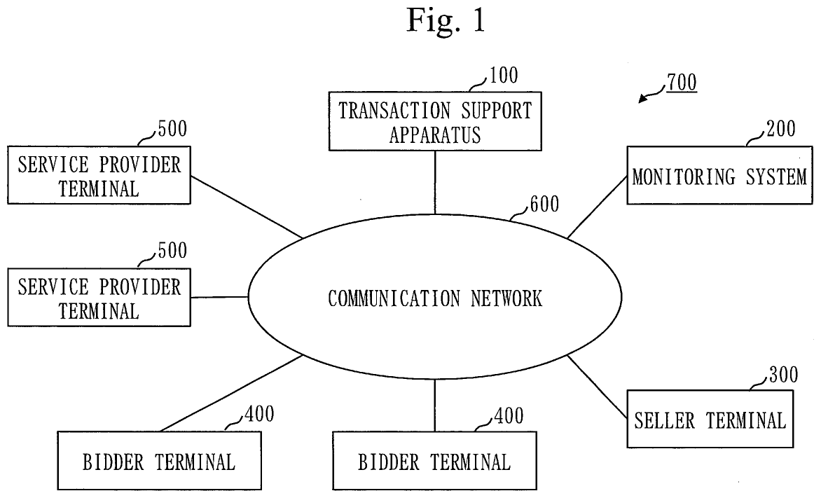

FIG. 1 illustrates a configuration example of a transaction support system 700 according to the present embodiment.

The transaction support system 700 according to the present embodiment facilitates a transaction including transportation, of an item (hereinafter referred to as a listing item) listed by a seller for the purpose of sale.

In the present embodiment, an example will be described in which the listing item is an item placed in a facility such as a building of a company, a research institute, a factory, a warehouse, or the like. In the present embodiment, specifically, items are assumed to be such as an elevator, an air conditioner, an industrial robot, a machine tool, a control device, a fixture, a train car, and a part thereof (for example, a hoisting machine of the elevator, or the like).

Such items are a large scale and heavy, and those structures are complicated. Therefore, transportation costs for such items tend to be high due to the following reasons.

Upon transportation of these items, a special skill is often required for a worker, for example. Further, upon the transportation of these items, a special packaging, and a special transportation means (a large truck or the like) are often required.

Further, these items may require a removal work at a departure place of transportation. It is assumed to require dismantlement of the item, detachment from a fixing device of the item, detachment of piping connected to the item, or the like, for example. Further, such a removal work may also require a worker who has a special skill.

Further, these items may require an installation work at an arrival place of transportation. It is assumed to require assembling of the item, attachment to a fixing device of the item, attachment of piping to the item, or the like, for example. Further, such an installation work may also require a worker who has a special skill.

Therefore, when the seller pays a part or all of the transportation cost, it is important for the seller to make the most profitable transaction in total including the transportation cost.

In the transaction support system 700 according to the present embodiment, a transaction support apparatus 100, a monitoring system 200, a seller terminal 300, a bidder terminal 400, and a service provider terminal 500 are connected to a communication network 600.

The transaction support apparatus 100 is a computer that supports a transaction of a listing item.

In the present embodiment, the transaction support apparatus 100 is assumed to be a server apparatus, but the transaction support apparatus 100 may be implemented by cooperation with a plurality of computers on a cloud network.

The monitoring system 200 monitors a facility (a departure place of transportation) where equipment which is the listing item is placed.

If the facility where the equipment is placed is a building, the monitoring system 200 is a building monitoring system.

The monitoring system 200 may be a remote monitoring system that remotely and centrally monitors a plurality of facilities, or may be a local monitoring system that monitors individual facilities.

The seller terminal 300 is a computer used by the seller. The seller terminal 300 is, for example, a Personal Computer (PC).

It is assumed that there is a plurality of seller terminals 300.

The bidder terminal 400 is a computer used by a bidder who wishes to make a successful bid for the listing item. The bidder terminal 400 is, for example, a PC.

It is assumed that there is a plurality of bidder terminals 400.

The service provider terminal 500 is a computer used by a transportation service provider (hereinafter also simply referred to as a service provider). The service provider terminal 500 is also, for example, a PC.

The service provider provides a transportation service. The service provider may be a company or an individual. The transportation service provided by the service provider includes not only transportation (movement of the listing item) in a narrow sense, but also the removal work and the installation work. The transportation in the narrow sense is hereinafter referred to as a transportation work. The transportation service including the removal work, the transportation work, and the installation work is referred to as transportation in a broad sense. Further, it is assumed that the simple expression of “transportation” hereinafter means the transportation in the broad sense.

The communication network 600 is, for example, the Internet.

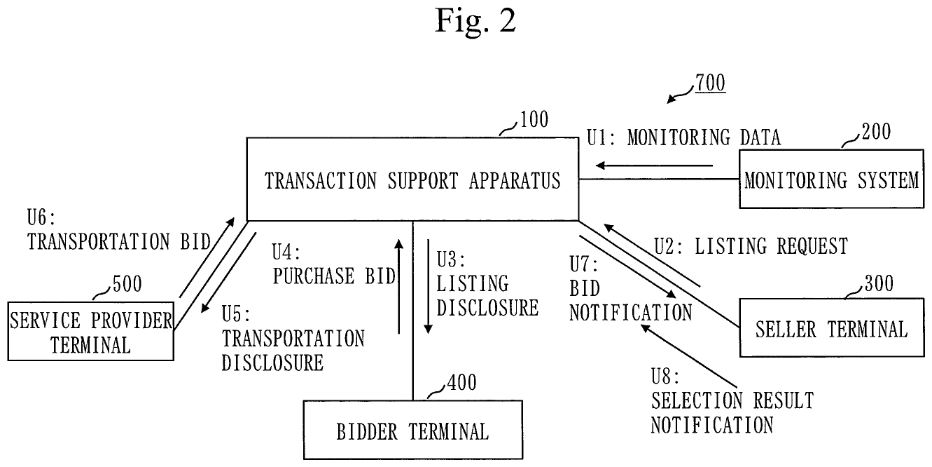

FIG. 2 illustrates an overview of operation of the transaction support system 700 according to the present embodiment.

Although only a single terminal is illustrated for each of the bidder terminal 400 and the service provider terminal 500 in FIG. 2, it is assumed that there is a plurality of bidder terminals 400 and a plurality of service provider terminals 500.

Further, although an illustration of the communication network 600 is omitted in FIG. 2, it is assumed that there is the communication network 600 between the transaction support apparatus 100, the monitoring system 200, the seller terminal 300, the bidder terminal 400, and the service provider terminal 500.

In step U1, the monitoring system 200 transmits monitoring data to the transaction support apparatus 100.

The monitoring data indicates a result of monitoring the facility by the monitoring system 200. The monitoring system 200 notifies in the monitoring data as to whether or not the equipment (an elevator, for example) included in the building is operating normally, a latest inspection date of the equipment, and the like, for example.

The monitoring system 200 transmits the monitoring data to the transaction support apparatus 100 at predetermined intervals.

The transaction support apparatus 100 accumulates the monitoring data.

In step U2, the seller terminal 300 issues a listing request to the transaction support apparatus 100.

The transaction support apparatus 100 generates listing item introduction information that introduces the listing item, using the monitoring data.

Then, the transaction support apparatus 100 performs a disclosure of the listing item in step U3. Specifically, the transaction support apparatus 100 discloses the listing item introduction information.

The transaction support apparatus 100 performs the disclosure by, for example, uploading the listing item introduction information on a website managed by the transaction support apparatus 100.

In step U4, each of the bidder terminals 400 performs a purchase bid. Specifically, each of the bidder terminals 400 transmits to the transaction support apparatus 100, a purchase bid message indicating a bid price (hereinafter referred to as a purchase bid price) for purchasing the listing item.

In step U5, the transaction support apparatus 100 performs a transportation disclosure Specifically, the transaction support apparatus 100 discloses transportation condition information. The transportation condition information indicates a condition of transportation of the listing item.

The transaction support apparatus 100 performs the transportation disclosure by, for example, uploading the transportation condition information on the website managed by the transaction support apparatus 100.

Next, in step U6, each of the service provider terminals 500 performs a transportation bid. Specifically, each of the service provider terminals 500 transmits to the transaction support apparatus 100, a transportation bid message indicating a bid price (hereinafter referred to as a transportation bid price) for the transportation cost of the listing item.

Next, in step U7, the transaction support apparatus 100 performs a bid notification. Specifically, the transaction support apparatus 100 transmits bid notification information to the seller terminal 300.

The bid notification information notifies of the purchase bid price and the transportation bid price. As a notification of the purchase bid price, the bid notification information indicates a burden transportation bid price or/and the transportation bid price. The burden transportation bid price is a price obtained by multiplying the transportation bid price by a burden rate of the transportation cost of the seller. If the burden rate of the seller is 50% (the remaining 50% is a burden on a successful bidder), the burden transportation bid price is a ½ price of the transportation bid price, for example.

Next, in step U8, the seller terminal 300 performs a selection result notification.

The seller refers to a plurality of purchase bid prices and a plurality of burden transportation bid prices/transportation bid prices indicated in the bid notification information to select a successful bidder and a successful bid service provider.

The successful bidder is a bidder who makes a successful bid for the listing item. That is, the successful bidder is a bidder who is granted the right to purchase the listing item.

The successful bid service provider is a service provider that makes a successful bid for a transportation service for the listing item. That is, the successful bid service provider is a service provider that is granted the right to transport the listing item.

The seller terminal 300 transmits to the transaction support apparatus 100, a selection result notification message indicating the successful bidder and the successful bid service provider.

After that, the transaction support apparatus 100 notifies the bidder terminal 400 of the successful bidder that the successful bidder has made a successful bid for the listing item. Further, the transaction support apparatus 100 notifies the service provider terminal 500 of the successful bid service provider that the successful bid service provider has made a successful bid for the transportation service for the listing item.

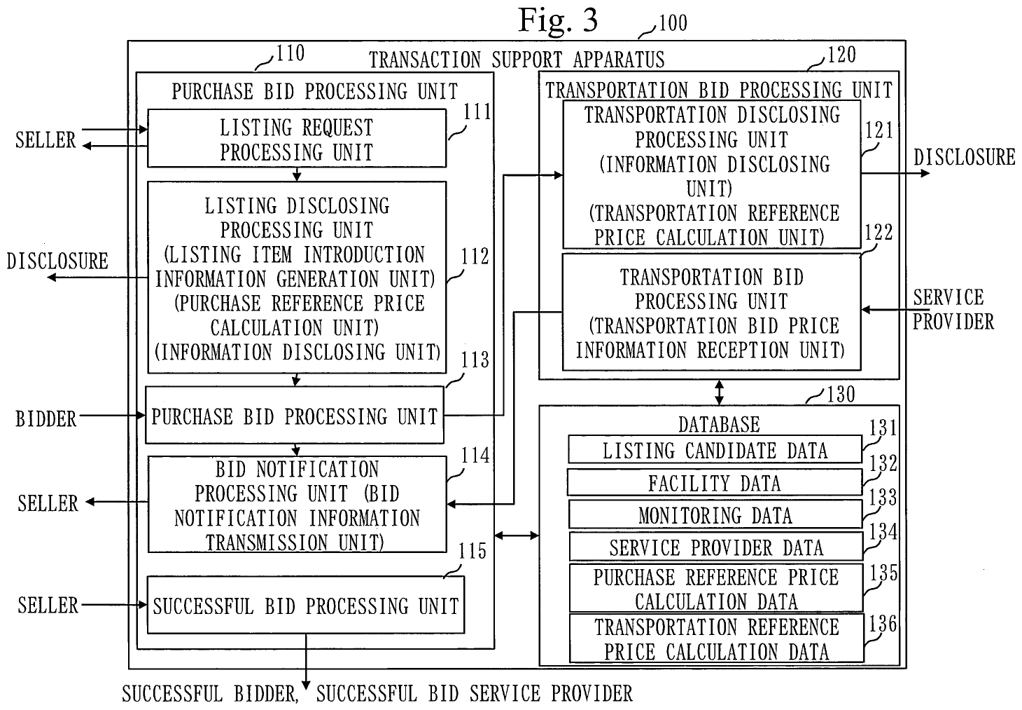

FIG. 3 illustrate a functional configuration example of the transaction support apparatus 100 according to the present embodiment.

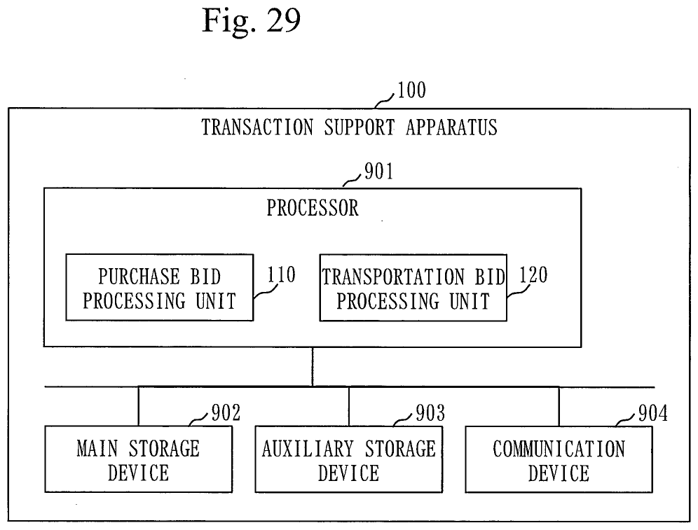

Further, FIG. 29 illustrates a hardware configuration example of the transaction support apparatus 100 according to the present embodiment.

First, the hardware configuration example of the transaction support apparatus 100 will be described with reference to FIG. 29.

The transaction support apparatus 100 according to the present embodiment is a computer. An operation procedure of the transaction support apparatus 100 is equivalent to a transaction support method. Further, a program that implements operation of the transaction support apparatus 100 is equivalent to a transaction support program.

The transaction support apparatus 100 includes a processor 901, a main storage device 902, an auxiliary storage device 903, and a communication device 904, as pieces of hardware.

The auxiliary storage device 903 stores programs that implement functions of a purchase bid processing unit 110 and a transportation bid processing unit 120 illustrated in FIG. 3.

These programs are loaded from the auxiliary storage device 903 into the main storage device 902. Then, the processor 901 executes these programs and performs operation of the purchase bid processing unit 110 and the transportation bid processing unit 120 to be described below.

FIG. 3 schematically illustrates a state where the processor 901 executes the programs that implement the functions of the purchase bid processing unit 110 and the transportation bid processing unit 120.

Further, a database 130 illustrated in FIG. 3 is implemented by, for example, the auxiliary storage device 903.

Next, a functional configuration example of the transaction support apparatus 100 will be described with reference to FIG. 3.

The transaction support apparatus 100 is configured with the purchase bid processing unit 110, the transportation bid processing unit 120, and the database 130.

The purchase bid processing unit 110 performs processes relating to the purchase of the listing item. That is, the purchase bid processing unit 110 performs the processes relating to steps U2 to U4, U7, and U8 of FIG. 2.

The transportation bid processing unit 120 performs processes relating to the transportation of the listing item. That is, the transportation bid processing unit 120 performs the processes relating to steps U5 and U6 of FIG. 2.

The database 130 holds data used by the purchase bid processing unit 110 and the transportation bid processing unit 120.

A listing request processing unit 111 processes the listing request from the seller in the purchase bid processing unit 110.

Specifically, the listing request processing unit 111 accepts the listing request from the seller, and presents the seller with a listing candidate list which is a list of items kept by the seller. Then, the listing request processing unit 111 accepts selection of a listing item by the seller.

A listing disclosing processing unit 112 generates the listing item introduction information that introduces the listing item, and discloses the generated listing item introduction information.

Further, the listing disclosing processing unit 112 calculates a purchase reference price when generating the listing item introduction information. The purchase reference price is a reference price for the purchase price of the listing item. The listing disclosing processing unit 112 writes the purchase reference price into the listing item introduction information.

The listing disclosing processing unit 112 is equivalent to a listing item introduction information generation unit, a purchase reference price calculation unit, and an information disclosing unit.

Further, processes performed by the listing disclosing processing unit 112 are equivalent to a listing item introduction information generation process, a purchase reference price calculation process, and an information disclosing process.

A purchase bid processing unit 113 accepts a purchase bid from a bidder.

A bid notification processing unit 114 notifies the seller of a bid status.

The bid notification processing unit 114 notifies the seller of the purchase bid price and the burden transportation bid price/the transportation bid price, as the bid status.

The bid notification processing unit 114 is equivalent to a bid notification information transmission unit. Further, a process performed by the bid notification processing unit 114 is equivalent to a bid notification information transmission process.

A successful bid processing unit 115 accepts the selection result notification from the seller.

Further, the successful bid processing unit 115 notifies the successful bidder that the successful bidder has made a successful bid for the listing item. Further, the successful bid processing unit 115 notifies the successful bid service provider that the successful bid service provider has made a successful bid for the transportation service for the listing item.

A transportation disclosing processing unit 121 generates the transportation condition information in the transportation bid processing unit 120.

Then, the transportation disclosing processing unit 121 discloses the generated transportation condition information.

Further, the transportation disclosing processing unit 121 calculates a transportation reference price when generating the transportation condition information. The transportation reference price is a reference price for transportation service provision for the listing item. The listing disclosing processing unit 112 writes the transportation reference price into the transportation condition information.

The listing disclosing processing unit 112 is equivalent to an information disclosing unit and a transportation reference price calculation unit.

Further, processes performed by the listing disclosing processing unit 112 are equivalent to an information disclosing process and a transportation reference price calculation process.

A transportation bid processing unit 122 accepts the transportation bid from the service provider.

The transportation bid processing unit 122 is equivalent to a transportation bid price information reception unit. Further, a process performed by the transportation bid processing unit 122 is equivalent to a transportation bid price information reception process.

The database 130 holds listing candidate data 131, facility data 132, monitoring data 133, service provider data 134, purchase reference price calculation data 135, and transportation reference price calculation data 136.

The listing candidate data 131 indicates a detail of an item kept by each user of the transaction support apparatus 100.

A plurality of users is registered as potential sellers in the transaction support apparatus 100. A plurality of items kept by each user is written in the listing candidate data 131, as potential listing items of each user.

The facility data 132 indicates a facility name and an address of a facility of each user.

A building, a factory, a research institute, a warehouse, a training facility, a recreation facility, or the like is considered as the facility.

The monitoring data 133 indicates a monitoring result by the monitoring system 200 of each item indicated in the listing candidate data 131. The monitoring data 133 indicates a state of each item, for example, an operation status, a maintenance status, and the like of each item.

The service provider data 134 indicates for each service provider, an area to provide a transportation service, and the presence or absence of a qualification and an education.

The purchase reference price calculation data 135 indicates a parameter for calculating the purchase reference price.

The transportation reference price calculation data 136 indicates a parameter for calculating the transportation reference price.

### Description of Operation

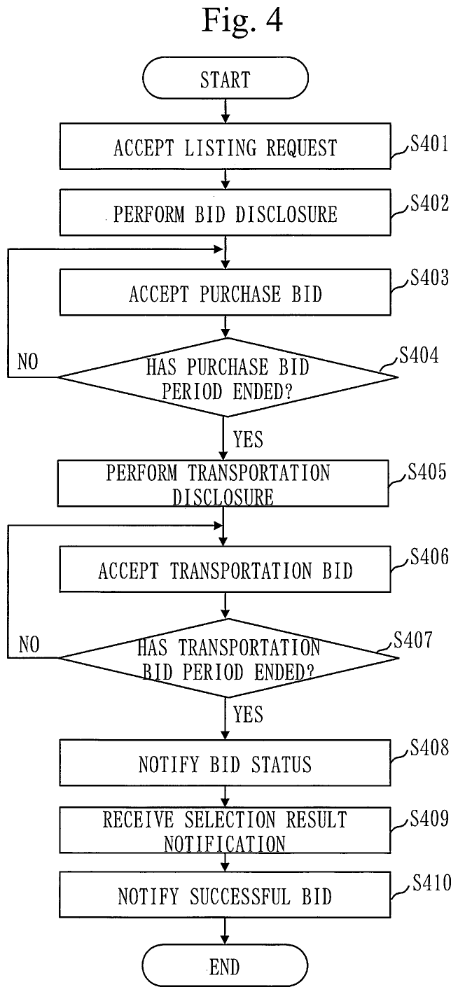

FIG. 4 illustrates an overview of the operation of the transaction support apparatus 100 according to the present embodiment.

In step S401, the listing request processing unit 111 accepts the listing request from the seller terminal 300.

Next, in step S402, the listing disclosing processing unit 112 performs the listing disclosure for the listing item specified by the seller.

Next, in step S403, the purchase bid processing unit 113 accepts the purchase bid from each of the bidder terminals 400.

Next, in step S404, the purchase bid processing unit 113 determines whether or not a purchase bid period has ended.

When the purchase bid period has ended, the process proceeds to step S405. On the other hand, the purchase bid period has not ended, the process returns to step S403.

The purchase bid period is a period during which the purchase bid is accepted.

In step S405, the transportation disclosing processing unit 121 performs the transportation disclosure.

Next, in step S406, the transportation bid processing unit 122 accepts the transportation bid from each of the service provider terminals 500.

Next, in step S407, the transportation bid processing unit 122 determines whether or not a transportation bid period has ended.

When the transportation bid period has ended, the process proceeds to step S408. On the other hand, the transportation bid period has not ended, the process returns to step S406.

The transportation bid period is a period during which the transportation bid is accepted.

Next, in step S408, the bid notification processing unit 114 notifies the seller terminal 300 of the bid status, based on the purchase bid accepted in step S403 and the transportation bid accepted in step S406.

Next, in step S409, the successful bid processing unit 115 receives the selection result notification from the transaction support apparatus 100.

Finally, in step S410, the successful bid processing unit 115 performs the successful bid notification to the bidder terminal 400 of the successful bidder and the service provider terminal 500 of the successful bid service provider.

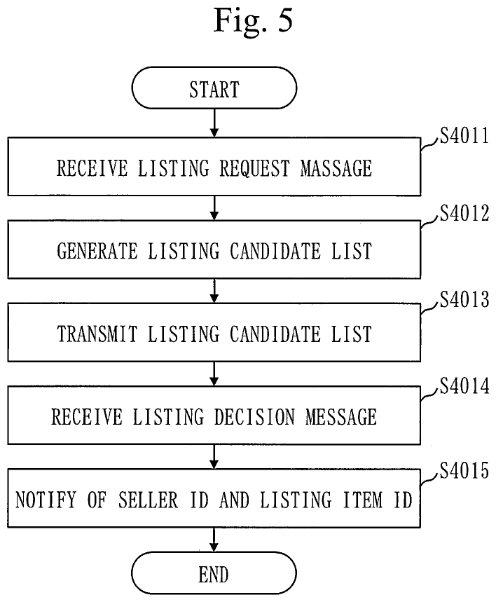

Next, details of step S401 (a listing request acceptance process) will be described with reference to FIG. 5.

In step S4011, the listing request processing unit 111 receives a listing request message from the seller terminal 300.

The listing request message is a message in which the seller requests the listing. A specific listing item is not specified in the listing request message.

The listing request message is assumed to include a user Identifier (ID) of the seller, as a seller ID.

In the following, the listing request message is assumed to include “AAA”, as the seller ID.

Further, descriptions of a login process, a user authentication process, and the like are omitted here for simplifying the descriptions. The login process, the user authentication process, and the like are assumed to be performed prior to the reception of the listing request message.

In step S4012, the listing request processing unit 111 generates the listing candidate list.

The listing candidate list is a list in which items kept by a user is listed.

The listing request processing unit 111 generates the listing candidate list, using the listing candidate data 131, for example.

The listing candidate data 131 and the listing candidate list will be described below.

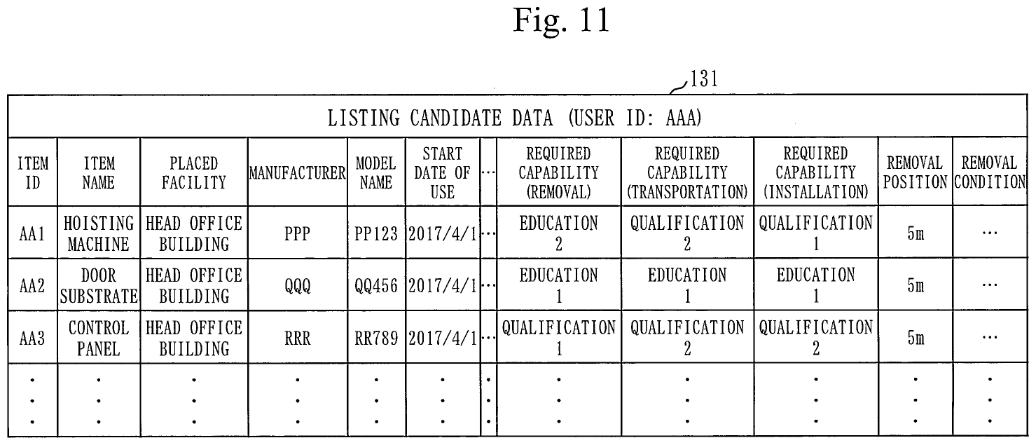

FIG. 11 illustrates an example of the listing candidate data 131.

The listing candidate data 131 indicates a detail of an item kept by each user.

In FIG. 11, an ID of an item is written in the column of “item ID”.

A name of the item is written in the column of “item name”.

A facility where the item is placed is written in the column of “placed facility”.

A name of a manufacturer of the item is written in the column of “manufacturer”.

A model name of the item is written in the column of “model name”.

A date on which the user has started to use the item is written in the column of “start date of use”

A required removal capability is indicated in the column of “required capability (removal)”. The required removal capability is a capability of the service provider required for the removal work for the item.

A required transportation capability is indicated in the column of “required capability (transportation)”. The required transportation capability is a capability of the service provider required for the transportation work for the item.

A required installation capability is indicated in the column of “required capability (installation)”. The required installation capability is a capability of the service provider required for the installation work for the item.

“Education 1” and “education 2” are writings to require a worker who has received a specific education to perform a work. A worker who has received “education 2” is required to perform the removal work for “hoisting machine” with “item ID: AA1” in FIG. 11. A service provider that does not have the worker who has received “education 2” cannot perform the removal work for “hoisting machine” with “item ID: AA1”.

“Qualification 1” and “qualification 2” in FIG. 11 are writings to require a worker who has a specific qualification to perform a work. A worker who has “qualification 1” is required to perform the installation work for “hoisting machine” with “item ID: AA1” in FIG. 11. A service provider that does not have the worker who has “qualification 1” cannot perform the installation work for “hoisting machine” with “item ID: AA1”.

A position where an item to be removed is placed is written in the column of “removal position”. A distance from an entrance/exit of the building is written in the column of “removal position”, for example.

An environment in which the removal work is performed, a degree of difficulty of the removal work, and the like are written in the column of “removal condition”. A floor (1st floor or 10th floor) on which the removal work is performed, and a transportation means (for example, stairs use, elevator use, crane use, or the like) from the floor are written in the column of “removal condition”, for example. Further, a size of a space where the removal work is performed, dimensions of an entrance/exit of the space where the removal work is performed, or the like may be written in the removal condition. Furthermore, the necessity of dismantlement of the item, the necessity of detachment of piping, or the like may be written in the removal condition.

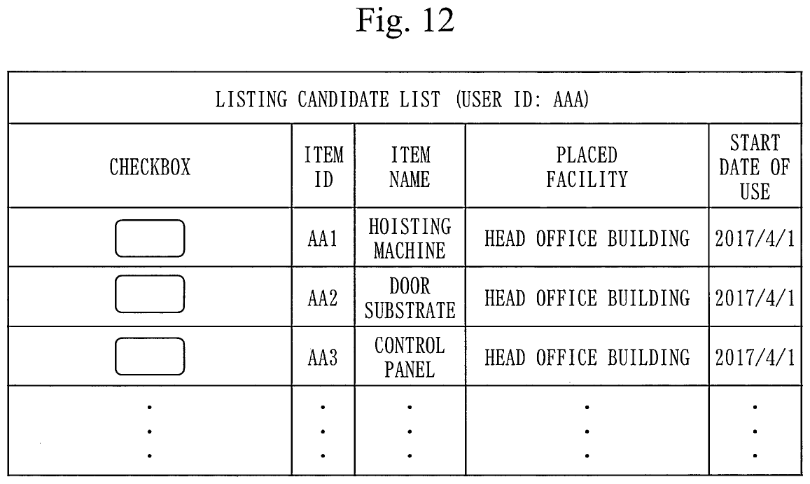

FIG. 12 illustrates an example of the listing candidate list.

The listing request processing unit 111 generates the listing candidate list, using, for example, the writings of the columns in “item ID” “item name”, “placed facility”, and “start date of use” in the listing candidate data 131.

Further, there is the column of “checkbox” in the listing candidate list. The seller can select a listing item by checking the checkbox of an item to be listed among items kept by the seller.

FIG. 12 is an example and the listing request processing unit 111 may include in the listing candidate list, another writing in the listing candidate data 131. The listing request processing unit 111 may include in the listing candidate list, writings in the columns of “manufacturer” and “model name” in the listing candidate data 131, for example.

In step S4013, the listing request processing unit 111 transmits the listing candidate list to the seller terminal 300, using the communication device 904.

Next, in step S4014, the listing request processing unit 111 receives a listing decision message from the seller terminal 300, using the communication device 904.

The listing decision message is the listing candidate list in a state where any of the checkboxes is checked by the seller.

Finally, in step S4015, the listing request processing unit 111 notifies the listing disclosing processing unit 112 of the seller ID and the listing item ID.

That is, the listing request processing unit 111 notifies the listing disclosing processing unit 112 of the user ID that has made the listing request, as the seller ID. Further, the listing request processing unit 111 notifies the listing disclosing processing unit 112 of the item ID of an item whose checkbox has been checked in the listing decision message, as the listing item ID.

Here, it is assumed that the listing request processing unit 111 notifies the listing disclosing processing unit 112 of “seller ID: AAA” and “listing item ID: AA1”, and “listing item ID: AA2”.

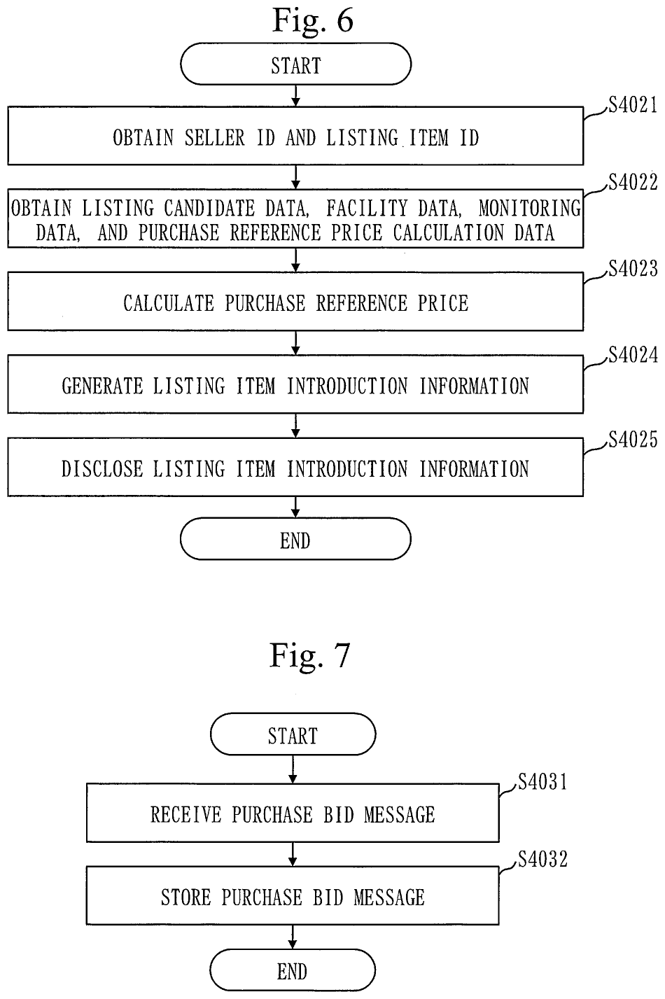

Next, details of step S402 (a listing disclosing process) will be described with reference to FIG. 6.

First, in step S4021, the listing disclosing processing unit 112 obtains from the listing request processing unit 111, the seller ID and the listing item ID.

Next, in step S4022, the listing disclosing processing unit 112 obtains the listing candidate data 131, the facility data 132, the monitoring data 133, and the purchase reference price calculation data 135.

Specifically, the listing disclosing processing unit 112 obtains the listing candidate data 131, the facility data 132, and the monitoring data 133 indicating the seller ID notified from the listing request processing unit 111, as the user ID.

Further, the listing disclosing processing unit 112 extracts from the obtained listing candidate data 131, the item name, the manufacturer, and the model name of the item ID corresponding to the listing item ID notified from the listing request processing unit 111. Then, the listing disclosing processing unit 112 obtains the purchase reference price calculation data 135 corresponding to the extracted item name, manufacturer, and model name.

Specific examples of the facility data 132, the monitoring data 133, and the purchase reference price calculation data 135 will be described below.

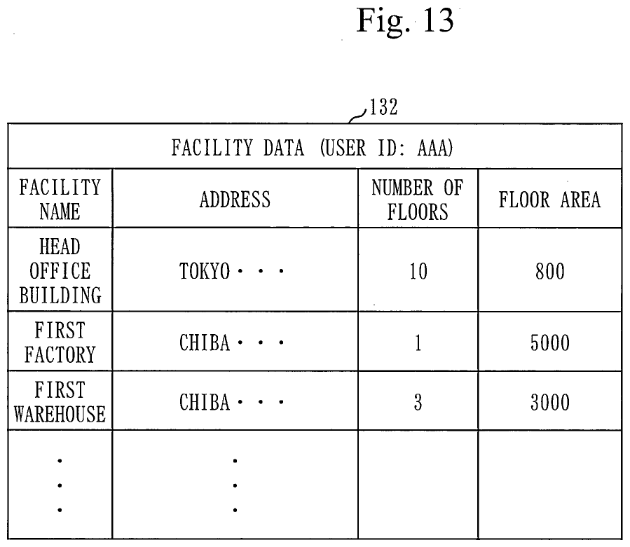

FIG. 13 illustrates an example of the facility data 132.

FIG. 13 illustrates the facility data 132 on “user ID: AAA” that is consistent with “seller ID: AAA”.

The facility data 132 indicates a facility name, an address, the number of floors, and a floor area, of a facility of the user.

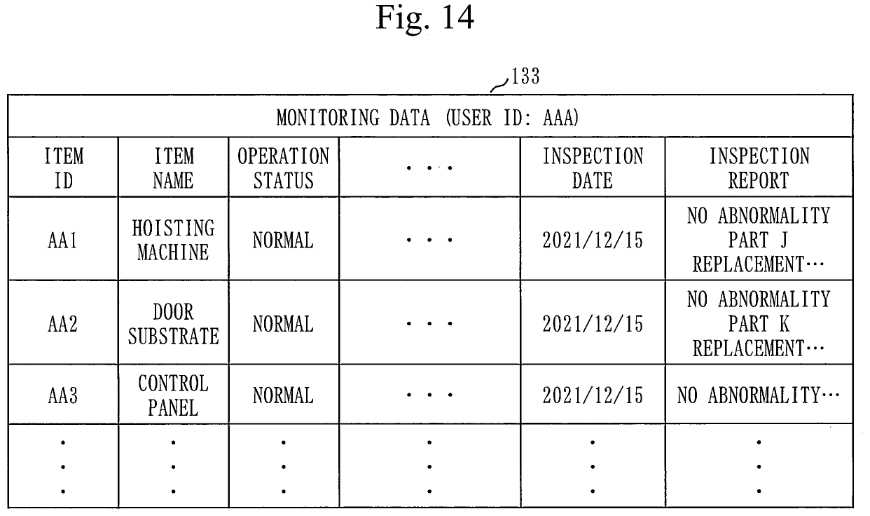

FIG. 14 illustrates an example of the monitoring data 133.

FIG. 14 illustrates the monitoring data 133 on “user ID: AAA” that is consistent with “seller ID: AAA”.

The monitoring data 133 indicates the monitoring result by the monitoring system 200 of each item indicated in the listing candidate data 131.

An operation status, an inspection data, and an inspection report of each item are written in the monitoring data 133, for example.

An inspection matter, a state of the item found during an inspection, the presence or absence of a part replacement, and the like are written in the inspection report.

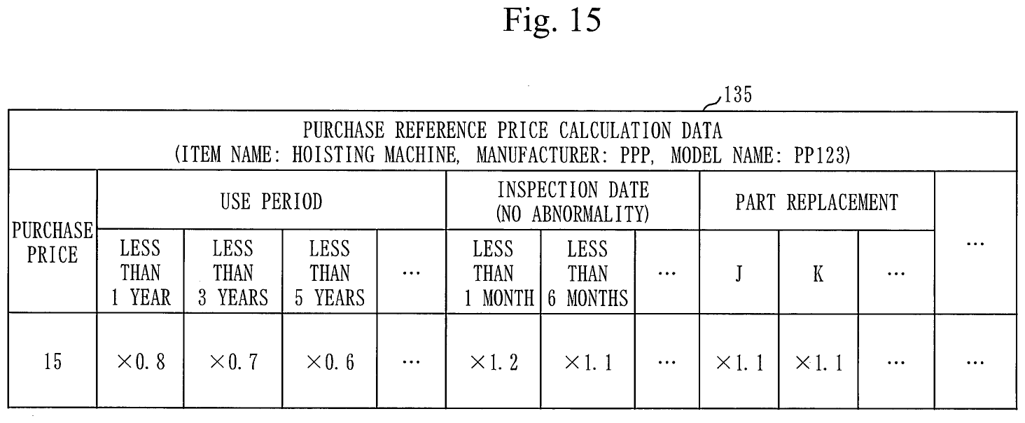

FIG. 15 illustrates an example of the purchase reference price calculation data 135.

FIG. 15 illustrates the purchase reference price calculation data 135 for “item name: hoisting machine”, “manufacturer: PPP”, and “model name: PP123” corresponding to “listing item ID: AA1”.

The purchase reference price calculation data 135 indicates a parameter for the calculation of the purchase reference price.

A purchase price, a use period, an inspection data, a part replacement, and the like are written in the purchase reference price calculation data 135 as parameters for the calculation of the purchase reference price, for example.

The values of “purchase price”, “purchase reference price”, “transportation reference price”, “purchase bid price”, and “transportation bid price” in FIG. 15 are abstracted values, and do not represent specific amount of money. However, as these values are high, the amount of money is high.

“Purchase price” is a price when the seller has purchased the listing item.

“×0.8”, “×1.2”, and the like in FIG. 15 are coefficient values by which the purchase price is multiplied.

Next, in step S4023, the listing disclosing processing unit 112 calculates the purchase reference price.

The listing disclosing processing unit 112 calculates the purchase reference price based on the purchase reference price calculation data 135.

An example of a calculation procedure of the purchase reference price will be described below.

For a listing item with “listing item ID: AA1”, the listing disclosing processing unit 112 calculates the use period from a difference between the current date and “start date of use: 2017 Apr. 1” in the listing candidate data 131 (FIG. 11), for example.

If the current date is “2022 Feb. 1”, the use period of the listing item is equal to or greater than 3 years and less than 5 years.

Therefore, the listing disclosing processing unit 112 selects “×0.6” written in “less than 5 years” of “use period” in the purchase reference price calculation data 135 (FIG. 15), as the coefficient value of the multiplication.

Further, the listing disclosing processing unit 112 calculates from a difference between the current date and “inspection data: 2021 Dec. 15” in the monitoring data 133 (FIG. 14), elapsed days from the inspection date.

If the current date is “2022 Feb. 1”, the elapsed days from the inspection date is equal to or more than 1 month and less than 6 months.

Further, “no abnormality” is written in “inspection report” in the monitoring data 133 (FIG. 14).

Therefore, the listing disclosing processing unit 112 selects “×1.1” written in “less than 6 months” of “inspection data (no abnormality)” in the purchase reference price calculation data 135 (FIG. 15), as the coefficient value of the multiplication.

Further, “part J replacement” is written in “inspection report” in the monitoring data 133 (FIG. 14).

Therefore, the listing disclosing processing unit 112 selects “×1.1” written in “J” of “part replacement” in the purchase reference price calculation data 135 (FIG. 15), as the coefficient value of the multiplication.

In such a manner, the listing disclosing processing unit 112 calculates the purchase reference price by multiplying the value of “purchase price” by the selected coefficient value.

Although the listing disclosing processing unit 112 calculates the purchase reference price by the multiplication here, the listing disclosing processing unit 112 may calculate the purchase reference price, using a difference calculation method.

Next, in step S4024, the listing disclosing processing unit 112 generates the listing item introduction information.

An example of a generation procedure of the listing item introduction information will be described below.

For the seller with “seller ID: AAA”, the listing disclosing processing unit 112 extracts from the listing candidate data 131 (FIG. 11), the writings of “item name”, “manufacturer”, “model name”, and “use period” of “listing item ID: AA1” and “listing item ID: AA2”.

Further, the listing disclosing processing unit 112 extracts from the monitoring data 133 (FIG. 14), the writings of “operation status”, “inspection date”, and “inspection report” of “listing item ID: AA1” and “listing item ID: AA2”.

Further, the listing disclosing processing unit 112 refers to the listing candidate data 131 (FIG. 11) to determine that the placed facility of the item with “listing item ID: AA1” and the item with “listing item ID: AA2” is “head office building”. Then, the listing disclosing processing unit 112 obtains from the facility data 132 (FIG. 13), “Tokyo” from the address of “head office building”.

Then, the listing disclosing processing unit 112 generates listing introduction information, using the writings extracted as described above and the purchase reference price calculated in step S4023.

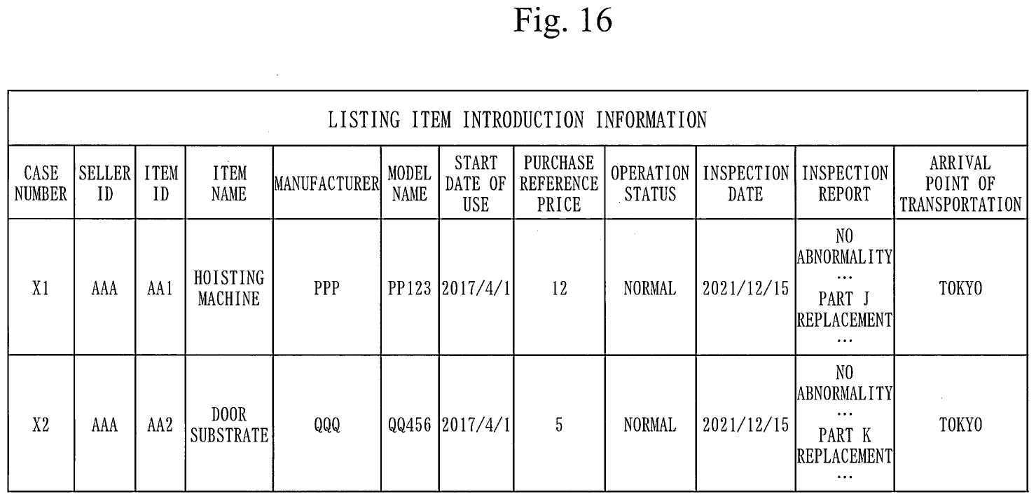

The listing disclosing processing unit 112 generates, for example, the listing introduction information indicated in FIG. 16.

The listing disclosing processing unit 112 assigns in the listing introduction information, a case number for each item ID. In the example of FIG. 16, “X1” and “X2” are assigned as case numbers.

Finally, in step S4025, the listing disclosing processing unit 112 discloses the listing introduction information.

The listing disclosing processing unit 112 uploads the listing item introduction information on the website managed by the transaction support apparatus 100, for example.

Further, at this time, the listing disclosing processing unit 112 activates a timer for managing the purchase bid period.

The bidder can view the listing item introduction information disclosed on the website managed by the transaction support apparatus 100, using the bidder terminal 400.

Then, the bidder transmits to the transaction support apparatus 100 from the bidder terminal 400, a purchase bid message that notifies of the purchase bid price of the listing item that the bidder wishes to make a successful bid.

Next, Details of step S403 (a purchase bid acceptance process) will be described with reference to FIG. 7.

In step S4031, the purchase bid processing unit 113 receives from the bidder terminal 400, the purchase bid message, using the communication device 904.

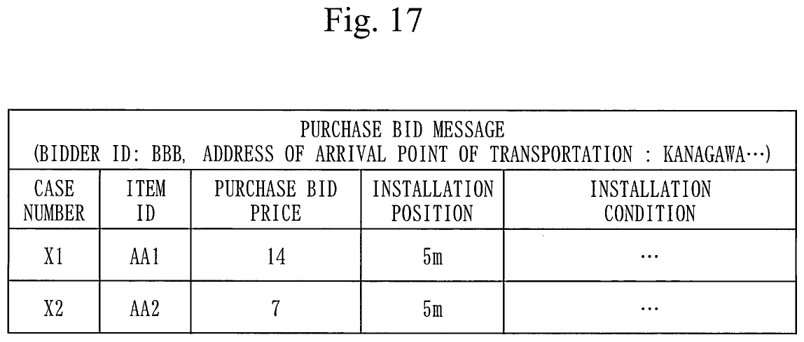

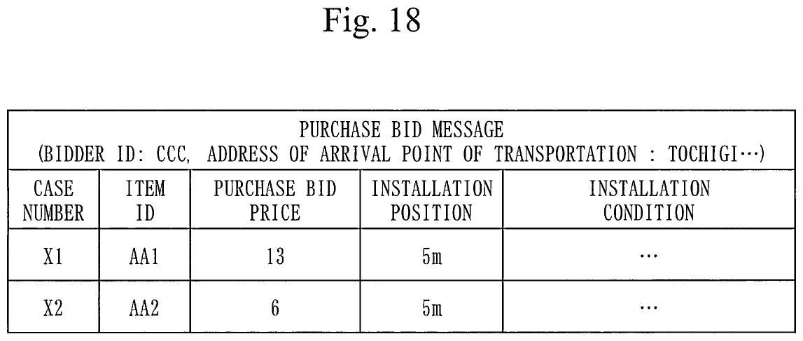

FIGS. 17 and 18 illustrate examples of the purchase bid message.

FIG. 17 illustrates an example of the purchase bid message from a bidder with “bidder ID: BBB”.

FIG. 18 illustrates an example of the purchase bid message from a bidder with “bidder ID: CCC”.

The purchase bid message indicates an address of an arrival point of transportation when the bidder makes a successful bid for the listing item. Further, the purchase bid price, the installation position, and the installation condition are indicated for each listing item that the bidder wishes to make a successful bid.

A position to which the item is installed is written in the column of “installation position”. A distance from an entrance/exit of the building is written in the column of “installation position”, for example.

An environment in which the installation work is performed, a degree of difficulty of the installation work, and the like are written in the column of “installation condition”. A floor (1st floor or 10th floor) on which the installation work is performed, and a transportation means (for example, stairs use, elevator use, crane use, or the like) to the floor are written in the column of “installation condition”, for example. Further, a size of a space where the installation work is performed, dimensions of an entrance/exit of the space where the installation work is performed, or the like may be written in the installation condition. Furthermore, the necessity of assembling of the item dismantled for the transportation work, the necessity of attachment of piping, or the like may be written in the installation condition.

Next, in step S4032, the purchase bid processing unit 113 stores the received purchase bid message into the database 130.

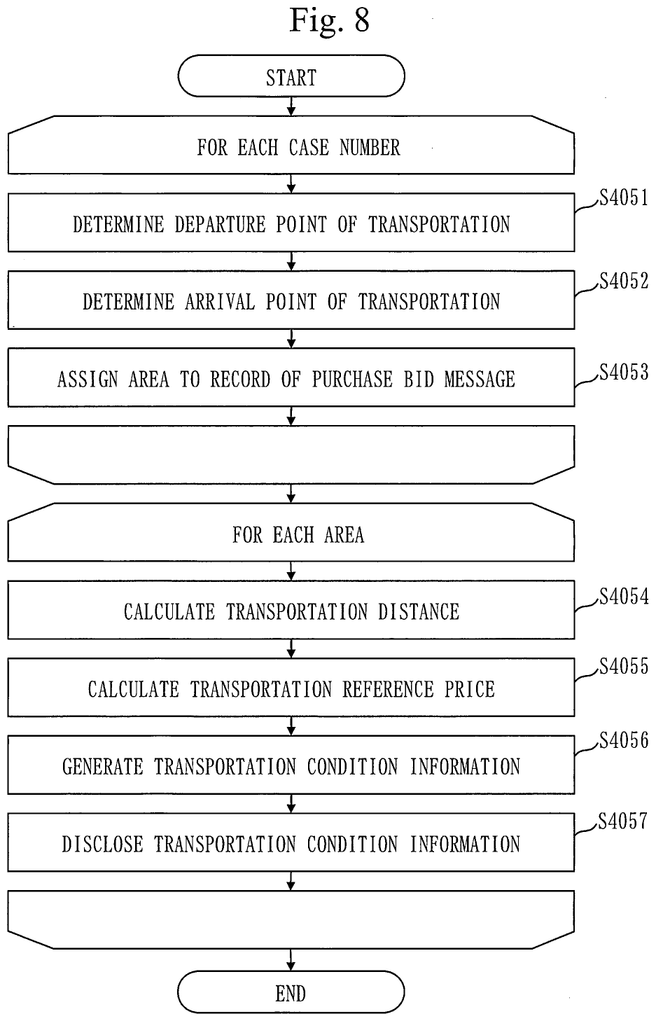

Next, details of step S405 (a transportation disclosing process) will be described with reference to FIG. 8.

As described above, step S405 (the transportation disclosing process) is performed after the purchase bid period ends. It is assumed that the transportation disclosing processing unit 121 has obtained from the database 130 before the start of the flow of FIG. 8, the listing item introduction information, the purchase bid message, and the like, used for the following processes.

In FIG. 8, steps S4051 to S4053 are performed for each case number.

When steps S4051 to S4053 are performed for one case number, the transportation disclosing processing unit 121 specifies a case number to be processed next.

After steps S4051 to S4053 are performed for all case numbers, steps S4054 to S4057 are performed.

Steps S4054 to S4057 are performed for each area.

When steps S4054 to S4057 are performed for one area, the transportation disclosing processing unit 121 specifies an area to be processed next.

First, in step S4051, the transportation disclosing processing unit 121 determines the departure place of transportation corresponding to the case number currently subject to process.

Specifically, the transportation disclosing processing unit 121 refers to the column of “departure point of transportation” corresponding to the case number currently subject to process in the listing item introduction information (FIG. 16) to determine the departure place of transportation. If the case number currently being processed by the transportation disclosing processing unit 121 is “X1”, the transportation disclosing processing unit 121 determines that the departure place of transportation is “Tokyo”.

Next, in step S4052, the transportation disclosing processing unit 121 determines the arrival place of transportation corresponding to the case number currently subject to process.

Specifically, the transportation disclosing processing unit 121 searches for the purchase bid message in which the case number currently subject to process is written. Then, the transportation disclosing processing unit 121 refers to the address of the bidder written in the purchase bid message obtained by the search to determine the arrival place of transportation

If the case number currently being processed by the transportation disclosing processing unit 121 is “X1”, the transportation disclosing processing unit 121 obtains the purchase bid message of FIG. 17. Then, the transportation disclosing processing unit 121 determines that the departure place of transportation is “Kanagawa” as to the purchase bid message of FIG. 17. Further, the transportation disclosing processing unit 121 determines that the arrival place of transportation is “Tochigi” as to the purchase bid message of FIG. 18.

Next, in step S4053, the transportation disclosing processing unit 121 assigns an area to a record corresponding to the purchase bid message.

Specifically, the transportation disclosing processing unit 121 determines whether or not the departure place of transportation determined in step S4051 and the arrival place of transportation determined in step S4052 are in the same area.

When the departure place of transportation and the arrival place of transportation are in the same area, the transportation disclosing processing unit 121 assigns the name of the area to a row corresponding to the purchase bid message. The departure place of transportation of the case number “X1” is “Tokyo”, for example. The arrival place of transportation is “Kanagawa” as to the purchase bid message of FIG. 17. Since “Tokyo” and “Kanagawa” are in the “Kanto” area, the transportation disclosing processing unit 121 assigns “Kanto” to the record (the record of “case number: X1”) in the first row of the purchase bid message of FIG. 17. Further, the arrival place of transportation is “Tochigi” as to the purchase bid message of FIG. 18. Since “Tokyo” and “Tochigi” are also in the “Kanto” area, the transportation disclosing processing unit 121 assigns “Kanto” to the record (the record of “case number: X1”) in the first row of the purchase bid message of FIG. 18.

On the other hand, when the departure place of the transportation and the arrival place of transportation are in different areas, the transportation disclosing processing unit 121 determines the smallest broader area concept, among broader area concepts that include the departure place of transportation and the arrival place of transportation. It is assumed that the departure place of transportation is “Tokyo”, and the arrival place of transportation is “Sendai”, for example. Further, it is assumed that there are “eastern Honshu”, “entire Honshu”, and “nationwide”, as the broader area concepts that include “Tokyo” and “Sendai”. In this case, the transportation disclosing processing unit 121 assigns to the record corresponding to the purchase bid message, “eastern Honshu” which is the smallest broader area concept.

Next, when steps S4051 to S4053 are completed for all case numbers, the transportation disclosing processing unit 121 performs the processes from step S4054 onwards for each area.

In step S4054, the transportation disclosing processing unit 121 calculates a transportation distance for each record of the purchase bid message to which the area currently subject to process is assigned.

That is, the transportation disclosing processing unit 121 calculates for each record of the purchase bid message, a distance between the departure place of transportation and the arrival place of transportation, as the transportation distance.

The transportation disclosing processing unit 121 calculates the transportation distance by the following procedure, for example.

Here, it is assumed that the transportation disclosing processing unit 121 processes the record (the record of “case number: X1”) in the first row of the purchase bid message of FIG. 17.

The transportation disclosing processing unit 121 obtains from the purchase bid message of FIG. 17, the address of the arrival point of transportation.

Further, the transportation disclosing processing unit 121 determines that the seller of “case number: X1” is the seller with “seller ID: AAA” in the listing item introduction information (FIG. 16). Then, the transportation disclosing processing unit 121 refers to the listing candidate data 131 (FIG. 11) to determine that the placed facility of the listing item (item ID: AA1) of “case number: X1” is “head office building”. Furthermore, the transportation disclosing processing unit 121 refers to the facility data 132 (FIG. 12) to obtain the address of “head office building”.

Then, the transportation disclosing processing unit 121 calculates the transportation distance from the address of the departure point of transportation and the address of the arrival point of transportation.

Next, in step S4055, the transportation disclosing processing unit 121 calculates the transportation reference price for each record of the purchase bid message to which the area currently subject to process is assigned.

The transportation reference price is a consolidated term for a reference price for the removal work, a reference price for the transportation work, and a reference price for the installation work. The transportation disclosing processing unit 121 calculates the reference price for the removal work, the reference price for the transportation work, and the reference price for the installation work.

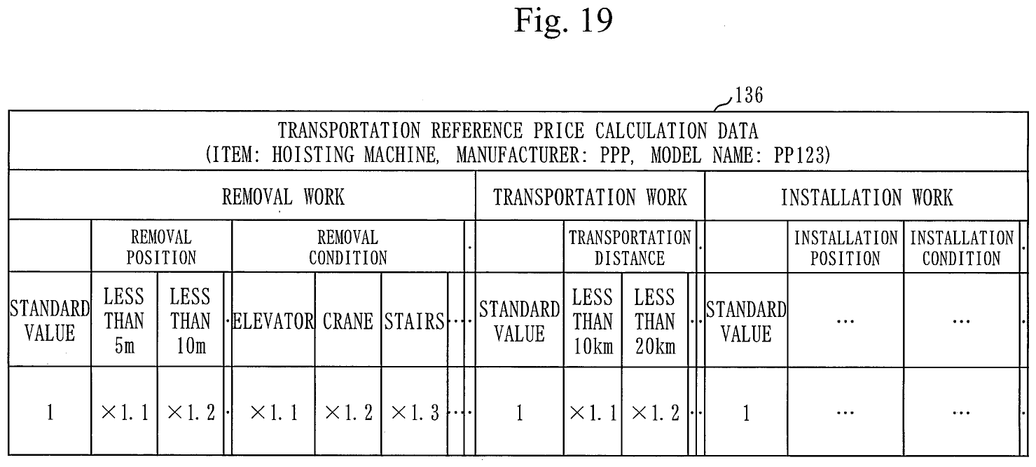

The transportation disclosing processing unit 121 calculates the transportation reference price, using the transportation reference price calculation data 136 indicated in FIG. 19, for example. The transportation reference price calculation data 136 is assumed to be prepared for each model name. FIG. 19 illustrates the transportation reference price calculation data 136 for the hoisting machine with “motel name: PP123” of “manufacturer: PPP”.

A parameter for calculating each of the reference prices for the removal work, transportation work, and the installation work is written in the transportation reference price calculation data 136. “×1.1”, “×1.2”, and the like in FIG. 19 are coefficient values by which a standard value is multiplied.

The transportation disclosing processing unit 121 calculates the reference price for the removal work by multiplying the standard value by the coefficient values corresponding to the writings of the removal position and the removal condition in the listing candidate data 131, for example.

“Removal position” of “hoisting machine” with “item ID: AA1” is “5 m” in the listing candidate data 131 of FIG. 11, for example. Therefore, the transportation disclosing processing unit 121 uses the coefficient value “×1.2” of “less than 10 m” in the transportation reference price calculation data 136. Further, if “elevator use” is written as the transportation means in “removal condition” of “hoisting machine” with “item ID: AA1” in the listing candidate data 131 of FIG. 11, the transportation disclosing processing unit 121 uses the coefficient value “×1.1” of “elevator” in the transportation reference price calculation data 136, for example.

Further, the transportation disclosing processing unit 121 calculates the reference price for the transportation work by, for example, multiplying the standard value by the coefficient value corresponding to the transportation distance calculated in step S4054.

Furthermore, the transportation disclosing processing unit 121 calculates the installation reference price by, for example, multiplying the standard value by the coefficient values corresponding to the writings of the installation position and the installation condition in the purchase bid message.

Although the transportation disclosing processing unit 121 is assumed to calculate the transportation reference price by the multiplication here, the transportation disclosing processing unit 121 may calculate the transportation reference price, using a different calculation method.

Further, the transportation disclosing processing unit 121 may digitize the scale of the facility being the departure point of transportation, using the number of floors and the floor area written in the facility data 132, and calculate the transportation reference price, using the digitized scale of the facility being the departure point of transportation.

Next, in step S4056, the transportation disclosing processing unit 121 generates the transportation condition information.

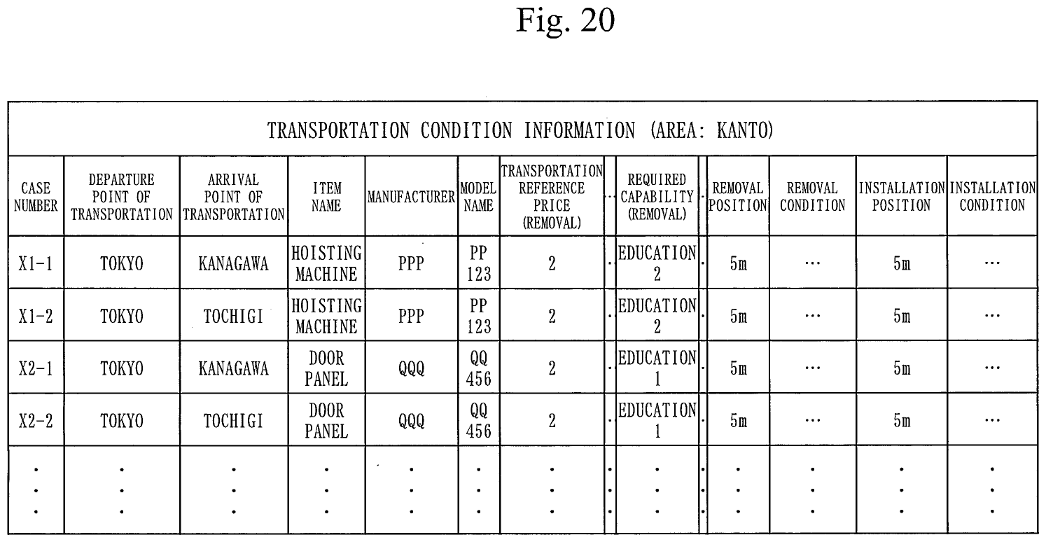

FIG. 20 illustrates an example of the transportation condition information.

The transportation disclosing processing unit 121 generates the transportation condition information by, for example, the following procedure.

The transportation disclosing processing unit 121 generates for each case number, a suffix corresponding to the number of records in the purchase bid message including the case number, and sets in the transportation condition information the case number to be written.

There are two records of the purchase bid message including “case number: X1”: the record in the first row of the purchase bid message of FIG. 17; and the record in the first row of the purchase bid message of FIG. 18. Therefore, the transportation disclosing processing unit 121 sets “case number: X1-1” and “case number: X1-2”.

Then, as illustrated in FIG. 20, the transportation disclosing processing unit 121 adds to each row of “case number: X1-1” and “case number: X1-2”, the departure point of transportation, the arrival point of transportation, the item name, and the like.

The transportation disclosing processing unit 121 uses the departure point of transportation determined in step S4051, for “departure point of transportation”. The transportation disclosing processing unit 121 uses the arrival point of transportation determined in step S4052, for “arrival point of transportation”. Further, the transportation disclosing processing unit 121 uses the writings in the listing candidate data 131, for “item name”, “manufacturer”, and “model name”.

The transportation condition information indicates the transportation reference price. Although only “transportation reference price (removal)” is illustrated in FIG. 20 for depiction convenience, the transportation condition information also includes “transportation reference price (transportation)” and “transportation reference price (installation)” in addition to “transportation reference price (removal)”. The transportation disclosing processing unit 121 uses the transportation reference price calculated in step S4055 for “transportation reference price (removal)”, “transportation reference price (transportation)”, and “transportation reference price (installation)”.

Further, the transportation condition information indicates the required capability. Although only “required capability (removal)” is illustrated in FIG. 20 for depiction convenience, the transportation condition information also includes “required capability (transportation)” and “required capability (installation)” in addition to “required capability (removal)”. The transportation disclosing processing unit 121 uses the writings in the listing candidate data 131 for “required capability (removal)”, “required capability (transportation)”, and “required capability (installation)”.

Further, the transportation disclosing processing unit 121 uses the writing in the listing candidate data 131 for “removal position”. Further, the transportation disclosing processing unit 121 uses the writing of “removal condition” in the listing candidate data 131 for “removal condition”.

Further, the transportation disclosing processing unit 121 uses the writing of “installation position” in the purchase bid message for “installation position”. Furthermore, the transportation disclosing processing unit 121 uses the writing of “installation condition” in the purchase bid message for “installation condition”.

Finally, in step S4057, the transportation disclosing processing unit 121 discloses the transportation condition information.

The transportation disclosing processing unit 121 uploads the transportation condition information on the website managed by the transaction support apparatus 100, for example.

Further, at this time, the transportation disclosing processing unit 121 activates a timer for managing the transportation bid period.

The service provider can view the transportation condition information disclosed on the website managed by the transaction support apparatus 100, using the service provider terminal 500. The service provider can efficiently view the transportation condition information by searching for the transportation condition information on the area where the service provider wishes the provision of the transportation service.

The service provider can present the transportation bid price only to a work that satisfies the required capability, among the removal work, the transportation work, and the installation work.

Then, the service provider transmits from the service provider terminal 500 to the transaction support apparatus 100, the transportation bid message that presents the transportation bid price for the case number for which the service provider wishes the provision of the transportation service.

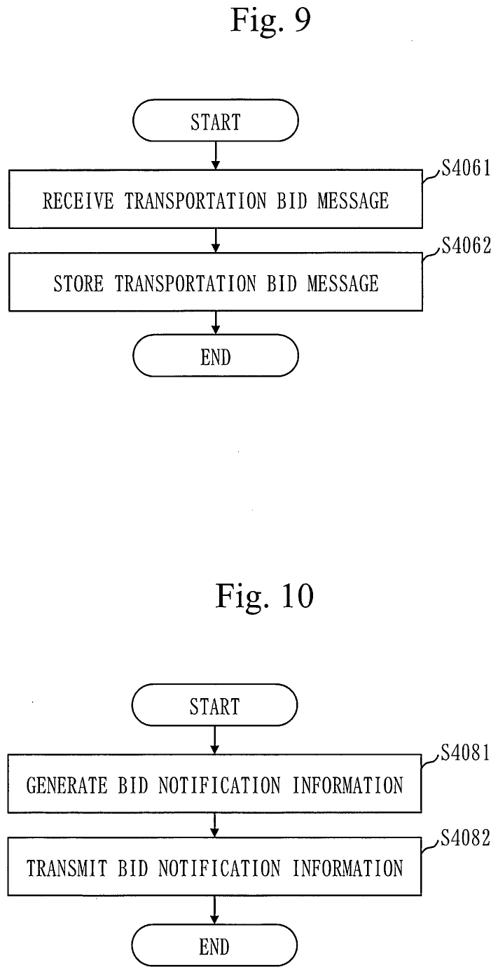

Next, details of step S406 (a transportation bid acceptance process) will be described with reference to FIG. 9.

In step S4061, the transportation bid processing unit 122 receives from the service provider terminal 500, the transportation bid message, using the communication device 904. The transportation bid message is an example of the transportation bid price information.

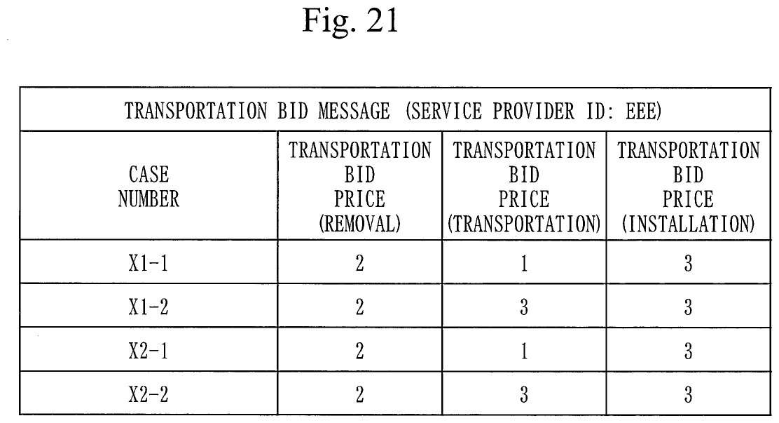

FIG. 21 illustrates an example of the transportation bid message.

FIG. 21 illustrates an example of the transportation bid message from the bidder with “service provider ID: EEE”.

The transportation bid message indicates the transportation bid price for each case number indicated in the transportation condition information. In FIG. 21, the column of “transportation bid price (removal)” indicates the transportation bid price for the removal work. The column of “transportation bid price (transportation) indicates the transportation bid price for the transportation work”. The column of “transportation bid price (installation)” indicates the transportation bid price for the installation work.

Next, in step S4062, the transportation bid processing unit 122 stores the received transportation bid message into the database 130.

Next, details of step S408 (a bid notification process) will be described with reference to FIG. 10.

As described above, step S408 (the bid notification process) is performed after the transportation bid period ends. The bid notification processing unit 114 is assumed to have obtained from the database 130 before the start of the flow of FIG. 10, the purchase bid message, the transportation bid message, and the like used for the following process.

First, in step S4081, the bid notification processing unit 114 generates the bid notification information.

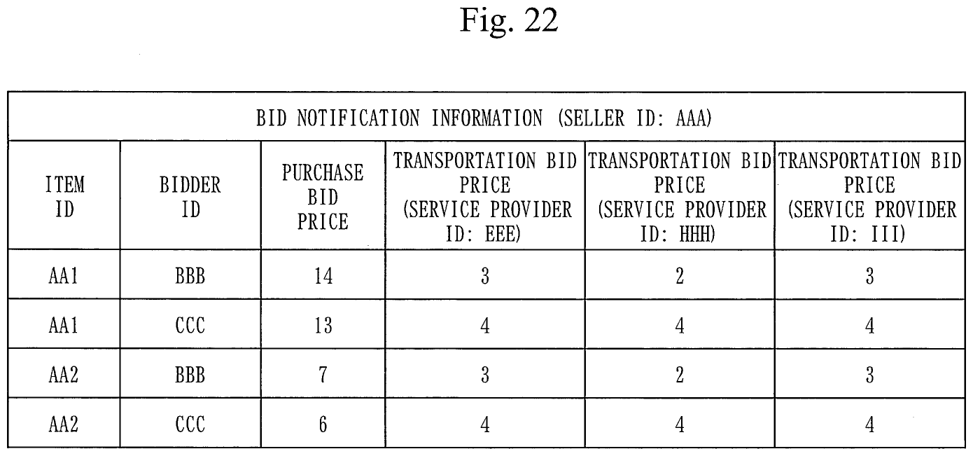

FIG. 22 illustrate an example of the bid notification information.

A generation procedure of the bid notification information will be described below with reference to FIG. 22.

The bid notification processing unit 114 generates for each item ID and each bidder ID, a record that consists of the purchase bid price and the transportation bid price by each service provider.

In the present embodiment, as illustrated in FIGS. 17 and 18, the purchase bid prices are presented by the bidder with “bidder ID: BBB” and the bidder with “bidder ID: CCC”, for each of “item ID: AA1” and “item ID: AA2”.

Therefore, the bid notification processing unit 114 generates a record corresponding to a combination of “item ID: AA1” and “bidder ID: BBB”, and a record corresponding to a combination of “item ID: AA1” and “bidder ID: CCC”.

Further, the bid notification processing unit 114 generates a record corresponding to a combination of “item ID: AA2” and “bidder ID: BBB”, and a record corresponding to a combination of “item ID: AA2” and “bidder ID: CCC”.

The purchase bid price presented in the purchase bid message is written in the column of “purchase bid price”.

The burden transportation bid price or the transportation bid price is written in the column of “transportation bid price”.

In FIG. 22, the burden transportation bid price is written in a case where a burden rate of the seller is 50% (the remaining 50% is a burden on the successful bidder). The burden transportation bid price in this case is a ½ price of the transportation bid price presented by each service provider. The transportation bid price presented by the service provider may be written instead of the burden transportation bid price.

Although the burden transportation bd price that covers “removal work”, “transportation work”, and “installation work” is written in FIG. 22 for depiction convenience, the burden transportation bid price or the transportation bid price may be written for each of “removal work”, “transportation work”, and “installation work” separately.

Further, both of the burden transportation bid price and the transportation bid price may be written.

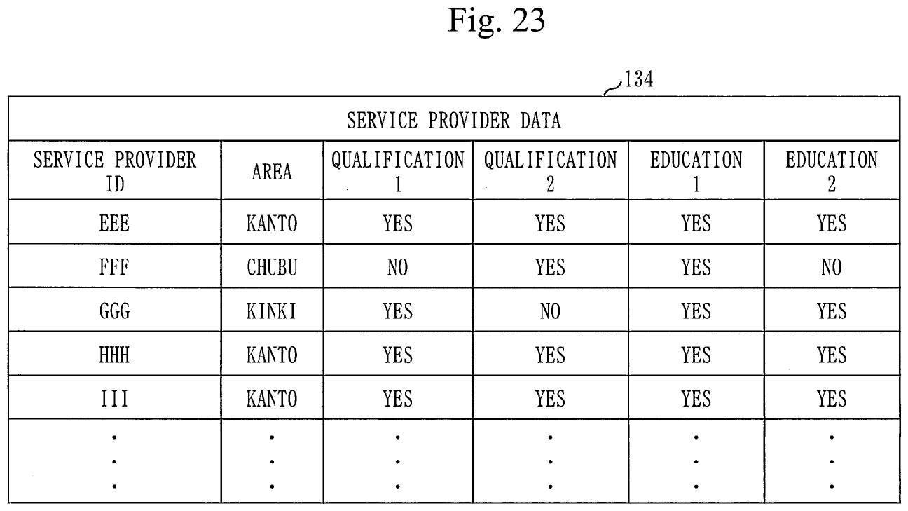

Further, the bid notification processing unit 114 refers to the service provider data 134 upon the generation of the bid notification information to determine whether or not each service provider has the required capability for each work of “removal work”, “transportation work”, and “installation work”. As illustrated in FIG. 23, the service provider data 134 indicates for each service provider, an area where a transportation service is provided, the presence or absence of a qualification and an education.

When the service provider does not satisfy the required capability for any of the works, the bid notification processing unit 114 treats a transportation bid price as invalid even if the transportation bid price is presented to the corresponding work. Then, the bid notification processing unit 114 writes into the bid notification information, that there is no transportation bid price for the corresponding work.

Next, in step S4082, the bid notification processing unit 114 transmits the bid notification information to the seller terminal 300, using the communication device 904.

The seller views the bid notification information, using the seller terminal 300.

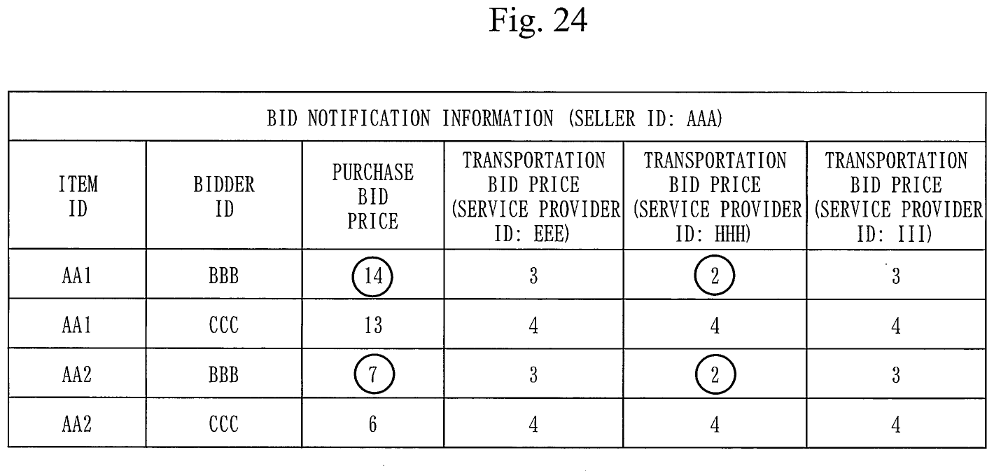

When viewing the bid notification information illustrated in FIG. 22, the seller determines that a combination of the purchase bid price and the transportation bid price circled in FIG. 24 has the highest profit for the seller.

The combination of “bidder ID: BBB” and “service provider ID: HHH” for “item ID: AAA1” has the highest profit for the seller, for example. That is, in the combination of “bidder ID: BBB” and “service provider ID: HHH”, the profit for the seller is “14−2=12”. On the other hand, in a combination of “bidder ID: BBB” and another service provider, the profit is only “14−3=11”. Further, for “bidder ID: CCC”, the profit is only “13−4=9” with all of the service providers.

Similarly, for “item ID: AAA2”, the combination “bidder ID: BBB” and “service provider ID: HHH” also has the highest profit for the seller.

After that, as illustrated in step U8 of FIG. 2, the seller performs the selection result notification, using the seller terminal 300.

In the example of FIG. 24, the selection result notification message indicating “successful bidder: BBB” and “successful bid service provider: HHH” for “item ID: AAA1” and “item ID: AAA2” is transmitted from the seller terminal 300 to the transaction support apparatus 100.

After that, the successful bid processing unit 115 notifies the bidder terminal 400 of the successful bidder that the listing item has been successfully bid. Further, the successful bid processing unit 115 notifies the service provider terminal 500 of the successful bid service provider that the transportation service for the listing item has been successfully bid.

### Description of Effects of Embodiment

In such a manner, in the present embodiment, a condition for transportation of a listing item is disclosed, and a bid from a transportation service provider is solicited. Further, in the present embodiment, a transportation bid price and a purchase bid price are notified to a seller. Therefore, according to the present embodiment, the seller can select the most profitable transaction in total including a transportation cost.

Further, according to the present embodiment, the seller can save an effort for searching for the transportation service provider that transports the listing item.

Further, according to the present embodiment, the transportation service provider can omit a sales activity for acquiring a transportation deal.

Further, in the present embodiment, a purchase reference price and a transportation reference price are disclosed. Therefore, according to the present embodiment, a bidder can present an appropriate purchase bid price. Further, the transportation service provider can present an appropriate transportation bid price. As a result, each of the seller, the bidder, and the transportation service provider can make a transaction comfortably.

Further, in the present embodiment, listing item introduction information is generated, using monitoring data on which an operation status, a maintenance status, and the like of the listing item are reflected. Therefore, when listing, the seller can save an effort for creating a document that explains the operation status, the maintenance status, and the like of the listing item. Further, the bidder can confirm the quality of the listing item before bidding.

Further, in the present embodiment, a required capability is disclosed in transportation condition information. Therefore, the transportation service provider can make a transportation bid after determining whether or not the required capability is satisfied, and it is possible to avoid a bid by a transportation service provider that does not satisfy the required capability.

Further, in the present embodiment, even if the bid is mistakenly made by the transportation service provider that does not satisfy the required capability, the transportation bid price from the transportation service provider is treated as invalid. Therefore, it is possible to avoid a case where a transportation service is provided by the transportation service provider that does not satisfy the required capability.

In the present embodiment, the description has been given, using an example of a case where a listing item is large scale equipment such as an elevator, an air conditioner, an industrial robot, or the like. However, the listing item does not need to be such large scale equipment.

### Embodiment 2

In Embodiment 1, there is no particular procedure to decide the burden rate of the transportation cost between the seller and the successful bidder.

The burden rate of the transportation cost may be decided uniformly (for example, to be split equally between the seller and the successful bidder) in the operation policy of the transaction support system 700, or may be decided individually for each listing item, for example.

In the present embodiment, an example will be described in which the burden rate of the transportation cost for each listing item is individually decided.

In the present embodiment as well, a configuration example of the transaction support system 700 is as illustrated in FIG. 1. Further, an operation procedure in the transaction support system 700 is as illustrated in FIG. 2. Further, a functional configuration example of the transaction support apparatus 100 is as illustrated in FIG. 3. Further, a hardware configuration example of the transaction support apparatus 100 is as illustrated in FIG. 29.

In the present embodiment, differences from Embodiment 1 will be mainly described. Matters not described below are the same as those in Embodiment 1.

In the present embodiment, in the listing disclosure in step U3 of FIG. 2, the transaction support apparatus 100 discloses the burden rate desired by the seller.

Then, in the purchase bid in step U4 of FIG. 2, the bidder terminal 400 presents the burden rate desired by the bidder.

For the bidder who agrees to the burden rate desired by the seller, the transaction support apparatus 100 decides the burden rate desired by the seller, as a final burden rate.

For the bidder who does not agree to the burden rate desired by the seller, the transaction support apparatus 100 decides the final burden rate, based on the burden rate presented by the bidder and the burden rate desired by the seller. The transaction support apparatus 100 decides as the final burden rate, a burden rate halfway between the burden rate presented by the bidder and the burden rate desired by the seller, for example.

Then, the transaction support apparatus 100 transmits to the seller terminal 300, the bid notification information indicating the burden transportation bid price calculated based on the final burden rate, in the bid notification in step U7 of FIG. 2.

An operation example of the transaction support apparatus 100 according to the present embodiment will be descried below. Since processes other than processes to be described below are the same as those in Embodiment 1, descriptions thereof will be omitted.

In the present embodiment, the listing request processing unit 111 receives the listing decision message in which the burden rate desired by the seller is written, in step S4014 of FIG. 5, for example. In the present embodiment, it is assumed that the burden rate (for example, “seller: 0%, successful bidder: 100%”) desired by the seller is written in the listing decision message for each listing item, for example.

In step S4015 of FIG. 5, the listing request processing unit 111 notifies the listing disclosing processing unit 112 of the burden rate desired by the seller together with the seller ID and the listing item ID.

In step S4021 of FIG. 6, the listing disclosing processing unit 112 obtains the burden rate desired by the seller together with the seller ID and the listing item ID.

Then, in step S4024 of FIG. 6, the listing disclosing processing unit 112 generates the listing item introduction information in which the burden rate desired by the seller is written.

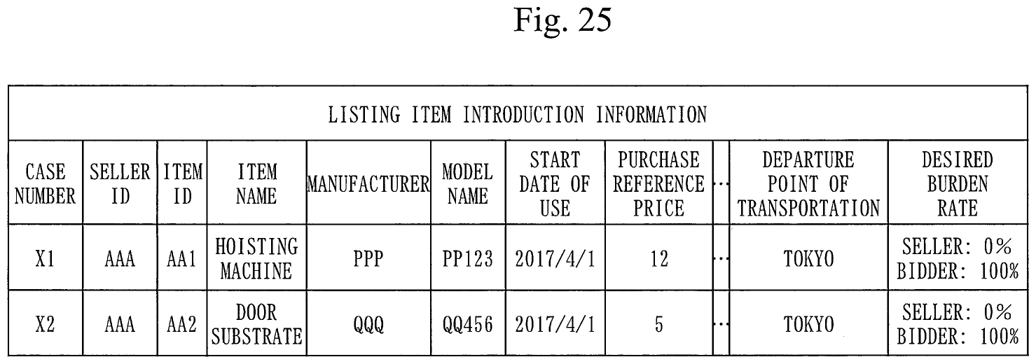

The listing disclosing processing unit 112 generates the listing item introduction information of FIG. 25, for example.

In the listing item introduction information of FIG. 25, the column of “desired burden rate” is added. The burden rate (“seller: 0%, successful bidder: 100%”) desired by the seller is written in the column of “desired burden rate”. Although illustrations of some columns are omitted for deception convenience in FIG. 25, the columns other than the column of “desired burden rate” are the same as those in the listing item introduction information illustrated in FIG. 16.

In step S4025 of FIG. 6, the listing disclosing processing unit 112 discloses the listing item introduction information of FIG. 25.

In the present embodiment as well, the bidder who has viewed the listing item introduction information transmits the purchase bid message from the bidder terminal 400 to the transaction support apparatus 100.

In the present embodiment, the bidder transmits from the bidder terminal 400 to the transaction support apparatus 100, the purchase bid message in which the desired burden rate of the transportation cost of the bidder is written.

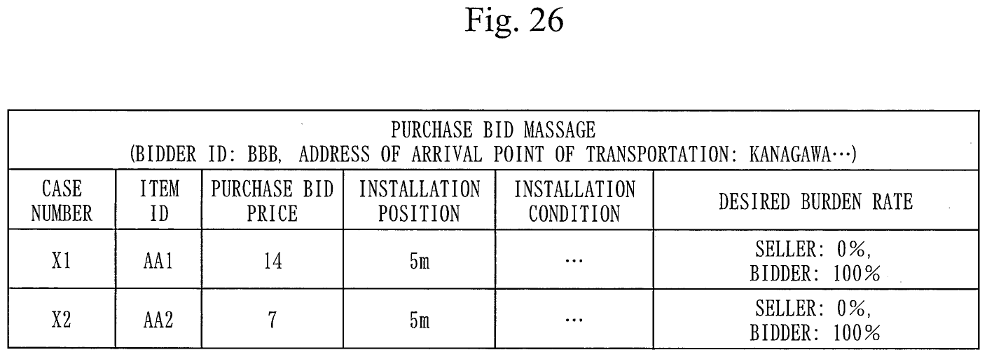

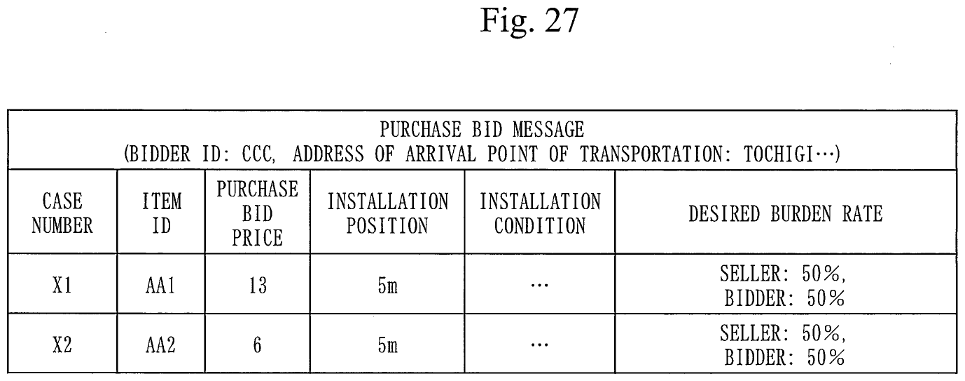

In the present embodiment, the purchase bid message of FIG. 26 and the purchase bid message of FIG. 27 are transmitted, for example.

In the purchase bid message of FIG. 26 and the purchase bid message of FIG. 27, the column of “desired burden rate” is added. The burden rate desired by the bidder is written in “desired burden rate”.

In the purchase bid message of FIG. 26, “seller: 0%, successful bidder: 100%” is written in the column of “desired burden rate”. That is, the bidder with “bidder ID: BBB” agrees to the desired burden rate of the seller.

On the other hand, in the purchase bid message of FIG. 27, “seller: 50%, successful bidder: 50%” is written in the column of “desired burden rate”. That is, the bidder with “bidder ID: CCC” does not agree to the desired burden rate of the seller.

The columns other than the column of “desired burden rate” of the purchase bid message of FIG. 26 and of the purchase bid message of FIG. 27 are the same as those of the purchase bid messages illustrated in FIGS. 17 and 18.

In the transaction support apparatus 100, the bid notification processing unit 114 generates the bid notification information in step S4081 of FIG. 10. At this time, for the bidder who agrees to the burden rate desired by the seller, the bid notification processing unit 114 decides the burden rate desired by the seller, as the final burden rate. Then, the bid notification processing unit 114 writes into the bid notification information, the burden transportation bid price calculated using the decided final burden rate.

On the other hand, for the bidder who does not agree to the burden rate desired by the seller, the bid notification processing unit 114 decides the final burden rate based on the burden rate presented by the bidder and the burden rate desired by the seller. The bid notification processing unit 114 decides the burden rate halfway between the burden rate presented by the bidder and the burden rate desired by the seller, as the final burden rate, for example. Then, the bid notification processing unit 114 writes into the bid notification information, the burden transportation bid price calculated using the decided final burden rate.

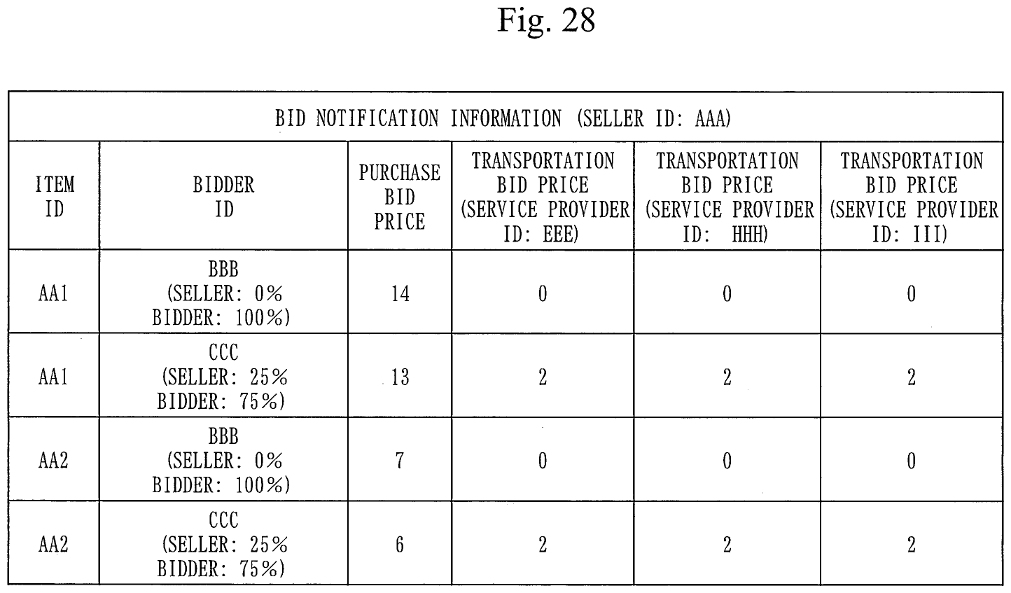

FIG. 28 illustrates an example of the bid notification information according to the present embodiment.

As described above, the bidder with “bidder ID: BBB” agrees to the desired burden rate (“seller: 0%, successful bidder: 100%”) of the seller. Therefore, all of transportation bid prices are “0” in a record indicating “bidder ID: BBB”. That is, the seller may not pay the transportation cost no matter which service provider is selected.

On the other hand, the bidder with “bidder ID: CCC” does not agree to the desired burden rate (“seller: 0%, successful bidder: 100%”) of the seller. Therefore, the bid notification processing unit 114 decides as the final burden rate, the burden rate (“seller: 25%, successful bidder: 75%”) halfway between the desired burden rate (“seller: 0%, successful bidder: 100%”) of the seller and the desired burden rate (“seller: 50%, successful bidder: 50%”) of the bidder with “bidder ID: CCC”. Then, the bid notification processing unit 114 writes into the bid notification information of FIG. 28, the burden transportation bid price (“2” for all of the service providers) calculated using the final burden rate.

In such a manner, according to the present embodiment, the burden rate of the transportation cost can be decided individually for each listing item.

Embodiments 1 to 2 have been described above and these two embodiments may be implemented in connection.

Alternatively, one of these two embodiments may be implemented partially.

Alternatively, these two embodiments may be implemented partially in connection.

Further, the configurations and procedures described above in these two embodiments may be modified as necessary.

### Supplementary Description of Hardware Configuration

Finally, a supplementary description of a hardware configuration of the transaction support apparatus 100 will be given.

The processor 901 illustrated in FIG. 29 is an Integrated Circuit (IC) that performs processing.

The processor 901 is a Central Processing Unit (CPU), a Digital Signal Processor (DSP), or the like.

The main storage device 902 illustrated in FIG. 29 is a Random Access Memory (RAM).

The auxiliary storage device 903 illustrated in FIG. 29 is a Read Only Memory (ROM), a flash memory, a Hard Disk Drive (HDD), or the like.

The communication device 904 illustrated in FIG. 29 is an electronic circuit that executes a communication process for data.

The communication device 904 is, for example, a communication chip or a Network Interface Card (NIC).

Further, the auxiliary storage device 903 also stores an Operating System (OS).

Then at least a part of the OS is executed by the processor 901.

While executing at least the part of the OS, the processor 901 executes programs that implement functions of the purchase bid processing unit 110 and the transportation bid processing unit 120.

By the processor 901 executing the OS, task management, memory management, file management, communication control, and the like are performed.

Further, at least one of information, data, a signal value, and a variable value that indicate results of processes of the purchase bid processing unit 110 and the transportation bid processing unit 120 is stored at least one of the main storage device 902, the auxiliary storage device 903, and a register and a cache memory in the processor 901.

Further, the programs that implement the functions of the purchase bid processing unit 110 and the transportation bid processing unit 120 may be stored in a portable recording medium such as a magnetic disk, a flexible disk, an optical disc, a compact disc, a Blu-ray (registered trademark) disc, or a DVD. Then, the portable recording medium storing the programs that implement the functions of the purchase bid processing unit 110 and the transportation bid processing unit 120 may be distributed.

Further, the “unit” of at least one of the components of the purchase bid processing unit 110 and the transportation bid processing unit 120 may be read as a “circuit”, “step”, “procedure”, “process”, or “circuitry”.

Further, the transaction support apparatus 100 may be implemented by a processing circuit. The processing circuit is, for example, a logic Integrated Circuit (IC), a Gate Array (GA), an Application Specific Integrated Circuit (ASIC), or a Field-Programmable Gate Array (FPGA).

In this case, each of the purchase bid processing unit 110 and the transportation bid processing unit 120 is implemented as a part of the processing circuit.

In the present description, a superordinate concept of the processor and the processing circuit is referred to as “processing circuitry”.

That is, each of the processor and the processing circuit is a specific example of the “processing circuitry”.

### REFERENCE SIGNS LIST

100: transaction support apparatus; 110: purchase bid processing unit; 111: listing request processing unit; 112: listing disclosing processing unit; 113: purchase bid processing unit; 114: bid notification processing unit; 115: successful bid processing unit; 120: transportation bid processing unit; 121: transportation disclosing processing unit; 122: transportation bid processing unit; 130: database; 131: listing candidate data; 132: facility data; 133: monitoring data; 134: service provider data; 135: purchase reference price calculation data; 136: transportation reference price calculation data; 200: monitoring system; 300: seller terminal; 400: bidder terminal; 500: service provider terminal; 600: communication network; 700: transaction support system; 901: processor; 902: main storage device; 903: auxiliary storage device; 904: communication device.

1. A transaction support apparatus comprising:
processing circuitry:
when a listing item that requires transportation has been listed by a seller, to disclose transportation condition information indicating a condition of the transportation of the listing item, using a communication network;
to receive from a transportation service provider, transportation bid price information indicating a transportation bid price which is a bid price for a transportation cost of the listing item, using the communication network; and
to transmit to the seller, bid notification information that notifies of a burden transportation bid price which is a price obtained by multiplying the transportation bid price by a burden rate of the seller decided based on a burden rate of the transportation cost of the seller desired by the seller and a burden rate of the transportation cost of the seller desired by a bidder of the listing item, using the communication network.

2. The transaction support apparatus according to claim 1, wherein
the processing circuitry transmits bid notification information that notifies of the burden transportation bid price and a purchase bid price which is a bid price for purchasing the listing item.

3. The transaction support apparatus according to claim 2, wherein
when there is a plurality of bidders who presents a purchase bid price of the listing item, the processing circuitry discloses for each bidder, transportation condition information indicating a condition of transportation of the listing item,
the processing circuitry receives for each bidder, transportation bid price information indicating a transportation bid price, and
the processing circuitry transmits for each bidder, bid notification information that notifies of the burden transportation bid price and a purchase bid price.

4. The transaction support apparatus according to claim 1, wherein
the processing circuitry may receive from a plurality of transportation service providers, a plurality of pieces of transportation bid price information, and
when the plurality of pieces of transportation bid price information is received, the processing circuitry transmits bid notification information that notifies of a plurality of the burden transportation bid prices based on a plurality of transportation bid prices of the plurality of transportation service provides indicated in the plurality of pieces of transportation bid price information.

5. The transaction support apparatus according to claim 1, wherein
the processing circuitry discloses transportation condition information indicating a required transportation capability which is a capability of a transportation service provider required for the transportation of the listing item, as the condition of transportation of the listing item, and
the processing circuitry receives transportation bid price information indicating a transportation bid price by the transportation service provider with a capability that conforms to the required transportation capability.

6. The transaction support apparatus according to claim 1, wherein
when transportation of the listing item includes a removal work for the listing item at a departure point of transportation and an installation work for the listing item at an arrival point of transportation in addition to a transportation work for the listing item, the processing circuitry receives transportation bid price information indicating a transportation bid price which is a bid price for a transportation cost including a cost for the transportation work, a cost for the removal work, and a cost for the installation work.

7. The transaction support apparatus according to claim 1, wherein
when transportation of the listing item includes a removal work for the listing item at a departure point of transportation and an installation work for the listing item at an arrival point of transportation in addition to a transportation work for the listing item, the processing circuitry discloses transportation condition information indicating a required transportation capability, a required removal capability, and a required installation capability which are capacities of a transportation service provider required for each of the transportation work, the removal work, and the installation work, as the condition of the transportation of the listing item, and
the processing circuitry receives transportation bid price information indicating a transportation bid price by the transportation service provider with capacities that conform to each of the required transportation capability, the required removal capability, and the required installation capability.

8. The transaction support apparatus according to claim 1, wherein
the processing circuitry calculates a reference price for a transportation cost of the listing item, and
the processing circuitry discloses transportation condition information indicating a condition of transportation of the listing item and the reference price for the transportation cost.

9. The transaction support apparatus according to claim 8, wherein
when transportation of the listing item includes a removal work for the listing item at a departure point of transportation and an installation work for the listing item at an arrival point of transportation in addition to a transportation work for the listing item, the processing circuitry calculates as the reference price for the transportation cost of the listing item, a reference price for a cost for the transportation work for the listing item, a reference price for a cost for the removal work, and a reference price for a cost for the installation work, and
the processing circuitry discloses transportation condition information indicating a condition of the transportation of the listing item, the reference price for the cost for the transportation work, the reference price for the cost for the removal work, and the reference price for the cost for the installation work.

10. The transaction support apparatus according to claim 1, wherein
the processing circuitry generates listing item introduction information that introduces the listing item and indicates a condition of the listing item obtained from monitoring by a monitoring system that monitors the condition of the listing item, and
the processing circuitry discloses the listing item introduction information.

11. The transaction support apparatus according to claim 10, wherein
the processing circuitry calculates a reference price for a purchase price of the listing item, and
the processing circuitry generates listing item introduction information indicating the reference price for the purchase price of the listing item.

12. A transaction support method comprising:
when a listing item that requires transportation has been listed by a seller, disclosing transportation condition information indicating a condition of the transportation of the listing item, using a communication network;
receiving from a transportation service provider, transportation bid price information indicating a transportation bid price which is a bid price for a transportation cost of the listing item, using the communication network; and
transmitting to the seller, bid notification information that notifies of a burden transportation bid price which is a price obtained by multiplying the transportation bid price by a burden rate of the seller decided based on a burden rate of the transportation cost of the seller desired by the seller and a burden rate of the transportation cost of the seller desired by a bidder of the listing item, using the communication network.

13. A non-transitory computer readable medium storing a transaction support program for causing a computer to execute:
an information disclosing process, when a listing item that requires transportation has been listed by a seller, to disclose transportation condition information indicating a condition of the transportation of the listing item, using a communication network;
a transportation bid price information reception process to receive from a transportation service provider, transportation bid price information indicating a transportation bid price which is a bid price for a transportation cost of the listing item, using the communication network; and
a bid notification information transmission process to transmit to the seller, bid notification information that notifies of a burden transportation bid price which is a price obtained by multiplying the transportation bid price by a burden rate of the seller decided based on a burden rate of the transportation cost of the seller desired by the seller and a burden rate of the transportation cost of the seller desired by a bidder of the listing item, using the communication network.
